(19) United States
(12) Patent Application Publication
(10) Pub. No.: US 2025/0091950 A1
(43) Pub. Date: Mar. 20, 2025

(54) GYPSUM BOARDS PREPARED USING UNCALCINED GYPSUM AND SLURRIES AND METHODS RELATED THERETO

(71) Applicant: United States Gypsum Company, Chicago, IL (US)

(72) Inventors: Yijun SANG, Oak Park, IL (US); Annamaria VILINSKA, Chicago, IL (US); Mark Kenneth HEMPHILL, Hawthorn Woods, IL (US)

(73) Assignee: United States Gypsum Company, Chicago, IL (US)

(21) Appl. No.: 18/749,547

(22) Filed: Jun. 20, 2024

Related U.S. Application Data
(60) Provisional application No. 63/583,779, filed on Sep. 19, 2023.

(51) Int. Cl. C04B 28/14; C04B 24/38; C04B 41/53; C04B 111/00

(52) U.S. Cl. CPC C04B 28/14; C04B 24/38; C04B 41/53; C04B 2111/0062

(57) ABSTRACT

Disclosed are gypsum boards, slurries, and methods of preparing gypsum board using water, uncalcined gypsum, stucco, and starch binder. The board contains a set gypsum core disposed between two cover sheets. The uncalcined gypsum and starch binder surprisingly and unexpectedly allows for the use of uncalcined gypsum while maintaining desired characteristics in gypsum wallboard, such as low board weight, sufficient strength, score/snap, fire resistance, etc. In embodiments, the presence of the uncalcined gypsum with the starch binder in the core slurry allows for excluding an amount of stucco therein.

### CROSS-REFERENCE TO RELATED APPLICATION

This patent application claims the benefit of U.S. Provisional Patent Application 63/583,779, filed Sep. 19, 2023, which is incorporated by reference.

### BACKGROUND

Set gypsum is a well-known material that is used in many products, including panels and other products for building construction and remodeling. One such panel (often referred to as gypsum board) is in the form of a set gypsum layer sandwiched between two cover sheets (e.g., paper-faced board) and is commonly used in drywall construction of interior walls and ceilings of buildings. One or more dense layers, often referred to as “skim coats” can be included on either side of the core, usually at the paper-core interface.

Gypsum (calcium sulfate dihydrate) is naturally occurring and can be mined in rock form. It can also be in synthetic form (referred to as “syngyp” in the art) as a by-product of industrial processes such as flue gas desulfurization. From either source (natural or synthetic), gypsum can be calcined at high temperature to form stucco (i.e., calcined gypsum primarily in the form of calcium sulfate hemihydrate) and then rehydrated to form set gypsum in a desired shape (e.g., as a board).

During manufacture of the board, stucco (i.e., calcined gypsum in the form of calcium sulfate hemihydrate and/or calcium sulfate anhydrite), water, and other ingredients as appropriate are mixed in a mixer (e.g., a pin mixer known in the art). A slurry is formed and discharged from the mixer onto a moving conveyor carrying a cover sheet with one of the skim coats (if present) already applied (often upstream of the mixer). The slurry is spread over the paper (with skim coat optionally included on the paper). Another cover sheet, with or without skim coat, is applied onto the slurry to form the sandwich structure of desired thickness with the aid of, e.g., a forming plate or the like. The mixture is cast and allowed to harden to form set (i.e., rehydrated) gypsum by reaction of the calcined gypsum with water to form a matrix of crystalline hydrated gypsum (i.e., calcium sulfate dihydrate). It is the desired hydration of the calcined gypsum that enables the formation of the interlocking matrix of set gypsum crystals, thereby imparting strength to the gypsum structure in the product. Heat is required (e.g., in a kiln) to drive off the remaining free (i.e., unreacted) water to yield a dry product.

Conventionally, calcium sulfate dihydrate (gypsum) is supplied to a board manufacturing plant and converted to calcium sulfate hemihydrate (stucco) in a calciner under high heat. As a result, the manufacture of wallboard is conventionally energy intensive due to calcination needs of stucco (and board drying processes). Thus, there exists a need to make gypsum board production more sustainable and efficient.

It will be appreciated that this background description has been created by the inventors to aid the reader, and is not to be taken as a reference to prior art nor as an indication that any of the indicated problems were themselves appreciated in the art. While the described principles can, in some regards and embodiments, alleviate the problems inherent in other systems, it will be appreciated that the scope of the protected innovation is defined by the attached claims, and not by the ability of any embodiments of the disclosure to solve any specific problem noted herein.

### BRIEF SUMMARY

The disclosure provides a gypsum board, a slurry, and methods of preparing a gypsum board. The gypsum board contains a set gypsum core disposed between a face cover sheet and a back cover sheet. The set gypsum core is formed from a core slurry. Calcium sulfate material herein refers to stucco (calcium sulfate hemihydrate or calcium sulfate anhydrate, also known as calcined gypsum) or land plaster (calcium sulfate dihydrate, also known as uncalcined gypsum). The calcium sulfate material provided in the core slurry in accordance with embodiments of the disclosure includes both stucco and land plaster, unlike conventional core slurries where the calcium sulfate material is provided in the core slurry in the form of stucco alone.

In this respect, the core slurry of embodiments of the disclosure comprises water, uncalcined gypsum, stucco, and starch binder. The gypsum board can be in the form of wallboard. As used herein, the term “wallboard” is not limited to the use of the board on walls, but can also include boards used for ceilings, partitions, etc. The board includes a set gypsum core disposed between first and second cover sheets (commonly face and back sheets, respectively). The set gypsum core is formed from a gypsum slurry comprising water, uncalcined gypsum, stucco, and starch binder and optional ingredients as desired, including, for example, foaming agent, accelerator (e.g., heat resistant accelerator), retarder, migrating starch, and polyphosphate. The face side of the board normally is facing out and is visible when hanging in use, while the back side faces inward, toward support structures such as studs.

Conventionally, the use of uncalcined gypsum in the core slurry has been undesired because it compromised strength of the board. Surprisingly and unexpectedly, the inventors have found that particular formulations and methods allow for the use of uncalcined gypsum while maintaining desired characteristics of a conventional wallboard, such as low board weight, sufficient strength, score/snap, fire resistance, etc. In particular, the inventors have found that the use of starch binder, as described herein, with uncalcined gypsum and stucco in a slurry allows for producing board with good strength. As a result, the board can be made while consuming less energy as lower amounts of material from a gypsum source needs to be calcined at high temperatures to form stucco. In this regard, a slurry can be formulated to substitute uncalcined gypsum for some of the stucco that is conventionally used in the core slurry. The board is thusly made more efficiently and more sustainably as the process is less energy-intensive, allowing for the production of “green” board that is more environmentally sustainable.

Manufacturing efficiencies are also created as board output can be more efficiently achieved as less stucco is needed to be produced through the calcination process. Furthermore, a large amount of excess water is conventionally used in wallboard production and needs to be driven off through a drying process. Uncalcined gypsum, however, has less water demand than calcined gypsum, ultimately resulting in, advantageously, an overall reduction in the water needed in the core slurry (e.g., by at least 10%, such as at least 12%, at least 15%, at least 20%, etc., e.g., from 12% to 30%, from 12% to 25%, from 12% to 20%, 12% to 15%, etc.). Some embodiments of the disclosure provide water reduction of 15% to 30%, e.g., from 15% to 25%, from 15% to 20%, from 15% to 18%, etc.

Surprisingly and unexpectedly, the use of uncalcined gypsum, stucco, and starch binder advantageously provides good performance with respect to fluidity and water-demand. Accordingly, uncalcined gypsum can be used to replace a portion of gypsum stucco in gypsum composition in accordance with embodiments of the disclosure.

Thus, in one aspect, the present disclosure provides a gypsum board comprising a set gypsum core disposed between two cover sheets, the core formed from a slurry comprising water, uncalcined gypsum, stucco, and starch binder. In some embodiments, the starch binder comprising (a) at least one uncooked non-substituted starch having a hot water viscosity of from about 20 Brabender Units to about 300 Brabender Units when the viscosity is measured by the hot water viscosity assay (HWVA method) method as referred to herein, (b) at least one pregelatinized starch, or (c) a combination of (a) and (b). In some embodiments, the pregelatinized starch is in the form of a pregelatinized partially hydrolyzed starch, wherein the hydrolysis at least partially depolymerizes the starch via acid and/or enzyme modification, wherein the pregelatinized partially hydrolyzed starch has a characteristic of a viscosity from about 35 centipoise to about 425 centipoise when the viscosity is measured while the pregelatinized partially hydrolyzed starch is subjected to conditions according to VMA method as referred to herein.

In another aspect of the invention, the disclosure provides a method of making gypsum board, the method comprising mixing a slurry comprising water, uncalcined gypsum, a stucco, and a starch binder, the starch binder comprising (a) at least one uncooked non-substituted starch having a hot water viscosity of from about 20 Brabender Units to about 300 Brabender Units when the viscosity is measured by the HWVA method, (b) at least one pregelatinized starch, or (c) a combination of (a) and (b). In some embodiments, the pregelatinized starch is in the form of a pregelatinized partially hydrolyzed starch, wherein the hydrolysis at least partially depolymerizes the starch via acid and/or enzyme modification, wherein the pregelatinized partially hydrolyzed starch has a characteristic of a viscosity from about 35 centipoise to about 425 centipoise when the viscosity is measured while the pregelatinized partially hydrolyzed starch is subjected to conditions according to VMA method. In some embodiments, the method also comprises placing the slurry between two cover sheets to form a board precursor; allowing the slurry in the precursor to set to form the board; and cutting the board.

In another aspect of the invention, the present disclosure provides a gypsum board comprising a set gypsum core disposed between two cover sheets, the core formed from a slurry comprising water, uncalcined gypsum, stucco, and starch binder. In some embodiments, the starch binder comprising (a) at least one uncooked non-substituted starch having a hot water viscosity of from about 20 Brabender Units to about 300 Brabender Units when the viscosity is measured by the HWVA method, (b) at least one pregelatinized starch, or (c) a combination of (a) and (b). In some embodiments, the pregelatinized starch is in the form of a pregelatinized partially hydrolyzed starch, wherein the hydrolysis at least partially depolymerizes the starch via acid and/or enzyme modification, wherein the pregelatinized partially hydrolyzed starch has a characteristic of a viscosity from about 35 centipoise to about 425 centipoise when the viscosity is measured while the pregelatinized partially hydrolyzed starch is subjected to conditions according to VMA method as referred to herein. For example, in some embodiments, the uncalcined gypsum is provided in the slurry in an amount from 25% to 150% by weight of the stucco, such as from 30% to 100%, from 40% to 100%, from 50% to 100%, from 60% to 100%, from 70% to 100%, from 80% to 100%, from 90% to 100%, from 20% to 90%, from 20% to 80%, from 20% to 70%, or from 25% to 50%. In some embodiments, the starch binder is provided in the slurry in an amount from 2% to 15% by weight of the stucco, such as from 5% to 15%, from 5% to 12%, or from 8% to 10%. Further, in some embodiments, the slurry has a water/stucco ratio of less than 1.0, such as from 0.3 to 1.0, from 0.5 to 0.9, or from 0.6 to 0.85. In embodiments, the board has a nail pull resistance of at least 72 pounds according to ASTM 473-10, such as from 72 pounds to 120 pounds, from 72 pounds to 115 pounds, from 72 pounds to 110 pounds, from 72 pounds to 105 pounds, from 72 pounds to 100 pounds, from 72 pounds to 90 pounds, or from 72 pounds to 80 pounds, and/or a core hardness of at least 11 pounds as determined according to ASTM 473-10, such as from 11 pounds to 35 pounds, from 11 pounds to 30 pounds, 11 pounds to 25 pounds, 11 pounds to 20 pounds, or 11 pounds to 15 pounds.

In another aspect of the invention, the present disclosure provides a method of making gypsum board, the method comprising mixing a slurry comprising water, uncalcined gypsum, a stucco, and a starch binder, the starch binder comprising (a) at least one uncooked non-substituted starch having a hot water viscosity of from about 20 Brabender Units to about 300 Brabender Units when the viscosity is measured by the HWVA method, (b) at least one pregelatinized starch, or (c) a combination of (a) and (b). In some embodiments, the pregelatinized starch is in the form of a pregelatinized partially hydrolyzed starch, wherein the hydrolysis at least partially depolymerizes the starch via acid and/or enzyme modification, wherein the pregelatinized partially hydrolyzed starch has a characteristic of a viscosity from about 35 centipoise to about 425 centipoise when the viscosity is measured while the pregelatinized partially hydrolyzed starch is subjected to conditions according to VMA method as referred to herein. For example, in some embodiments, the uncalcined gypsum is provided in the slurry in an amount from 25% to 150% by weight of the stucco, such as from 30% to 100%, from 40% to 100%, from 50% to 100%, from 60% to 100%, from 70% to 100%, from 80% to 100%, from 90% to 100%, from 20% to 90%, from 20% to 80%, from 20% to 70%, or from 25% to 50%. In some embodiments, the starch binder is provided in the slurry in an amount from 2% to 15% by weight of the stucco, such as from 5% to 15%, from 5% to 12%, or from 8% to 10%. Further, in some embodiments, the slurry has a water/stucco ratio of less than 1.0, such as from 0.3 to 1.0, from 0.5 to 0.9, or from 0.6 to 0.85. In some embodiments, the method also comprises placing the slurry between two cover sheets to form a board precursor; allowing the slurry in the precursor to set to form the board; and cutting the board. In some embodiments, the board has a nail pull resistance of at least 72 pounds according to ASTM 473-10, such as from 72 pounds to 120 pounds, from 72 pounds to 115 pounds, from 72 pounds to 110 pounds, from 72 pounds to 105 pounds, from 72 pounds to 100 pounds, from 72 pounds to 90 pounds, or from 72 pounds to 80 pounds, and/or a core hardness of at least 11 pounds as determined according to ASTM 473-10, such as from 11 pounds to 35 pounds, from 11 pounds to 30 pounds, 11 pounds to 25 pounds, 11 pounds to 20 pounds, or 11 pounds to 15 pounds.

In another aspect of the invention, the present disclosure provides a slurry comprising water, uncalcined gypsum, stucco, and starch binder, the starch binder comprising (a) at least one uncooked non-substituted starch having a hot water viscosity of from about 20 Brabender Units to about 300 Brabender Units when the viscosity is measured by the HWVA method, (b) at least one pregelatinized starch, or (c) a combination of (a) and (b). For example, in some embodiments, the uncalcined gypsum is provided in the slurry in an amount from 25% to 150% by weight of the stucco, such as from 30% to 100%, from 40% to 100%, from 50% to 100%, from 60% to 100%, from 70% to 100%, from 80% to 100%, from 90% to 100%, from 20% to 90%, from 20% to 80%, from 20% to 70%, or from 25% to 50%. In embodiments, the starch binder is provided in the slurry in an amount from 2% to 15% by weight of the stucco, such as from 5% to 15%, from 5% to 12%, or from 8% to 10%. Further, in some embodiments, the slurry has a water/stucco ratio of less than 1.0, such as from 0.3 to 1.0, from 0.5 to 0.9, or from 0.6 to 0.85.

Further and alternative aspects and features of the disclosed principles will be appreciated from the following detailed description. As will be appreciated, the slurries, boards, and methods disclosed herein are capable of being carried out and used in other and different embodiments, and capable of being modified in various respects. Accordingly, it is to be understood that both the foregoing general description and the following detailed description are exemplary and explanatory only and do not restrict the scope of the appended claims.

### DETAILED DESCRIPTION

The present disclosure provides gypsum board and methods of making gypsum board. The gypsum board contains a set gypsum core disposed between face and back cover sheets, respectively. The set gypsum core is formed from a slurry. In accordance with the present disclosure, uncalcined gypsum is included in the slurry as a substitute for some of the stucco to produce board with sufficient strength to be desired in the market. Surprisingly and unexpectedly, at least 20% of the stucco can be replaced with uncalcined gypsum (e.g., the core slurry containing uncalcined gypsum in an amount from 25 to 150% by weight of the stucco). While conventional use of uncalcined gypsum was not desired because it compromised board strength, the inventors have found that the use of a starch binder (as described herein) along with stucco allows for the use of uncalcined gypsum in the slurry formulation while producing the board with good strength. While not wishing to be bound by any particular theory, the stucco is hydrated to form needle crystals. The needles are believed to mingle and overlap to form a set gypsum matrix structure. Uncalcined gypsum particulates bind to the matrix mainly through hydrogen bonds, such that it is believed that the starch polymer molecules and hydrated stucco needles bind gypsum particles together through hydrogen bonds to enhance the strength of the resulting board.

The uncalcined gypsum, sometimes referred to as “land plaster,” can be in the form of ground natural rock or synthetic gypsum. Typically, in a gypsum board manufacturing facility, gypsum is sourced and provided to the facility as a raw material. The gypsum is subjected to a calcination process at high temperatures to form stucco. By replacing some of the stucco with uncalcined gypsum in the slurry for forming the board, the board manufacturing process requires less energy because not all of the raw gypsum sourced to the facility is calcinated. This allows for the production of “green” gypsum board with improved sustainability.

The uncalcined gypsum functions as an active filler. In this respect, the uncalcined gypsum does not react with water. It is an active filler because gypsum dihydrate contains approximately 21% chemically bonded water, which contributes to fire resistance. The uncalcined gypsum can be added to the slurry in any suitable manner. For example, it can be added in dry form by addition, e.g., with the stucco.

In addition, the efficiency and energy consumption of the board manufacturing process are further improved because the use of uncalcined gypsum in the slurry as a substitute for some of the stucco effectively permits the use of less water for reaction with the stucco. As such, the presence of the uncalcined gypsum allows for a slurry with lower water demand. The lower water demand enhances the sustainability and efficiency of the manufacturing process since less water needs to be driven off through the use of heat in a kiln. Similar to the need for less calcination, the use of less water reduces energy consumption during the manufacturing process and creates higher output of product.

Embodiments of the disclosure provide a slurry, gypsum board, and a method of preparing gypsum board using uncalcined gypsum to replace a significant amount of stucco (e.g., at least 20% by weight of the stucco) in a slurry for forming the set gypsum core. A starch binder interacts with stucco to form a dual binder system to permit the substitution of a portion (e.g., at least 25% by weight of the stucco) of stucco that would otherwise be included in the slurry with uncalcined gypsum. The gypsum board includes a board core comprising set gypsum sandwiched between face and back cover sheets. The set gypsum core is formed from the core slurry comprising water, uncalcined gypsum, stucco, and starch binder, and optional ingredients as desired, including, for example, but not limited to, foaming agent, accelerator (e.g., heat resistant accelerator), retarder, migrating starch, polyphosphate, fiber, etc. A dense layer (sometimes referred to as a “skim coat”) can be optionally disposed between the board core and the face cover sheet and/or between the board core and the back cover sheet. In accordance with embodiments of the disclosure, the dense layers are formed from one or more dense layer slurries (which can be the same or different) comprising water, uncalcined gypsum, stucco, and starch binder, and other ingredients as discussed herein. The dense layer generally has a significantly greater density and significantly lower thickness than that of the board core.

Embodiments of the disclosure provide a gypsum board that exhibits comparable and/or enhanced strength properties and water-demand to what is found in conventional wallboard, as well as related slurries and methods. To achieve such results, uncalcined gypsum, stucco, and starch binder is included in a gypsum slurry (sometimes referred to as a stucco slurry) for forming the set gypsum core, which is disposed between two cover sheets in the gypsum board. Surprisingly and unexpectedly, the inventors have discovered that board prepared with the inclusion of uncalcined gypsum, stucco, and starch binder in core slurry reduces water-demand while preserving nail pull strength with the use of less stucco than board made from a core slurry comprising stucco without any uncalcined gypsum (e.g., where the source of the calcium sulfate material is stucco alone).

Conventionally, the use of uncalcined gypsum has been known to significantly reduce the strength of gypsum board. By reducing a portion of the calcined gypsum (i.e., stucco) with an amount of uncalcined gypsum in a core slurry, conventionally, nail pull strength is generally compromised. To illustrate, in representative conventional boards prepared by replacing 20% of the stucco in a slurry with uncalcined gypsum by weight of the stucco, nail pull strength is undesirably reduced by 9 lbs or more (e.g., by at least 10 lbs, such as by at least 11 lbs, by at least 12 lbs, by at least 13 lbs, by at least 14 lbs, etc., e.g., from 9 lbs to 20 lbs, from 9 lbs to 15 lbs, from 9 lbs to 12 lbs, etc.). In another representative illustration, when 30% of stucco in a slurry is replaced with uncalcined gypsum, the nail pull strength can be detrimentally reduced by 19 lbs or more (e.g., by at least 20 lbs, such as by at least 25 lbs, by at least 30 lbs, etc., e.g., from 19 lbs to 30 lbs, from 19 lbs to 25 lbs, from 19 lbs to 22 lbs, etc.). In accordance with slurries, methods, and boards in accordance with the present disclosure, uncalcined gypsum can be used in the core slurry without these decreases in strength (e.g., nail pull strength).

Surprisingly and unexpectedly, the inventors discovered a method of binding uncalcined gypsum by a binary binder system (stucco and starch binder, e.g., acid-modified non-migrating starch) to make gypsum board. The board can be made using existing wallboard production systems and can be made using similar additives, including foaming agent, to introduce air voids to reduce board weight. The board formed with the use of uncalcined gypsum can be produced with good strength, e.g., with a nail pull strength of at least 72 lbs according to ASTM 473-10 in some embodiments, such as from 72 pounds to 120 pounds, from 72 pounds to 115 pounds, from 72 pounds to 110 pounds, from 72 pounds to 105 pounds, from 72 pounds to 100 pounds, from 72 pounds to 90 pounds, or from 72 pounds to 80 pounds.

The slurry for forming the set gypsum core of the board contains water, stucco, uncalcined gypsum, stucco, starch binder, and optional ingredients such as foaming agent, accelerator, retarder, migrating starch, polyphosphate, and other components as desired.

Stucco is sometimes referred to as calcined gypsum, and it can be in the form of calcium sulfate alpha hemihydrate, calcium sulfate beta hemihydrate, and/or calcium sulfate anhydrite. The calcined gypsum can be fibrous in some embodiments, nonfibrous in other embodiments, or a combination thereof in other embodiments. In embodiments, the calcined gypsum can include at least 50% beta calcium sulfate hemihydrate. In other embodiments, the calcined gypsum can include at least 86% beta calcium sulfate hemihydrate.

The weight ratio of water to gypsum can be any suitable ratio, although, as one of ordinary skill in the art will appreciate, lower ratios can be more efficient because less excess water will remain after the hydration process of the stucco is completed during manufacture, thereby conserving energy. For example, the core slurry formulations can be made with any suitable water/gypsum ratio, e.g., 0.6 to 2, 0.6 to 1.5, 0.6 to 1, 0.6 to 0.9, 0.6 to 0.85, 0.6 to 0.8, 0.6 to 0.75, 0.6 to 0.7, 0.6 to 0.65, 0.5 to 2, 0.5 to 1.5, 0.5 to 1, 0.5 to 0.9, 0.5 to 0.85, 0.5 to 0.8, 0.5 to 0.75, 0.5 to 0.7, 0.5 to 0.65, 0.4 to 2, 0.4 to 1.5, 0.4 to 1, 0.4 to 0.9, 0.4 to 0.85, 0.4 to 0.8, 0.4 to 0.75, 0.4 to 0.7, 0.4 to 0.65, 0.3 to 2, 0.3 to 1.5, 0.3 to 1, 0.3 to 0.9, 0.3 to 0.85, 0.3 to 0.8, 0.3 to 7.5, 0.3 to 0.7, 0.3 to 0.65, 0.3 to 0.5, 0.4 to 0.6, etc.

The amount of calcined gypsum provided in a slurry can be any suitable amount. For example, the core slurry formulations can be made with any amount of calcined gypsum, e.g., 800 lbs/MSF or less, such as from 550 to 700 lbs/MSF, from 600 to 700 lbs/MSF, from 650 to 700 lbs/MSF, from 600 lbs/MSF to 800 lbs/MSF, from 700 lbs/MSF to 800 lbs/MSF, etc.

Uncalcined gypsum (also referred to as land plaster or landplaster) is a gypsum product generally produced in powder form, usually white in color. The land plaster can be ground natural rock or synthetic gypsum which is the raw material used to make stucco through calcination process. Land plaster is generally non-toxic and may be manufactured for a variety of applications, including agricultural applications, for example. Uncalcined gypsum may be produced during the processing of gypsum ore. The inventors have discovered that the inclusion of uncalcined gypsum with a starch binder and stucco provides a significant benefit in reducing water-demand while preserving the nail pull strength properties of gypsum board.

Conventionally, uncalcined gypsum generally has not been used in the slurry for forming the set gypsum core because it may lead, e.g., to a reduction in the strength properties of the board. However, the inventors have discovered that the use of the starch binder may beneficially interact with the uncalcined gypsum to enhance strength. While not wishing to be bound by any theory, it is believed that the polymer molecules of the binder (starch) and hydrated stucco needles bind gypsum particles together through hydrogen bonds. The inventors have discovered that, surprisingly and unexpectedly, the combination of such a binder with uncalcined gypsum allows for the replacement of a portion of the stucco in the slurry with the uncalcined gypsum. Advantageously, replacement may enable for the use of less stucco, thereby, e.g., reducing the need for as much calcining as well as reducing water-demand and improving efficiency in making the board.

The uncalcined gypsum can have any suitable average particle size, e.g., less than 1000 μm, such as from 20 μm to 1000 μm, from 20 μm to 500 μm, from 20 μm to 100 μm, etc. In some embodiments, the weight ratio of stucco to uncalcined gypsum is from 3:1 to 1:1, such as from 2:1 to 1.2:1, or from 1.5:1 to 1.2:1, etc.

In some embodiments, the uncalcined gypsum is provided in an amount of from 20% to 150% by weight of the stucco, such as from 25% to 150%, e.g., from 20% to 150%; from 20% to 125%; from 20% to 100%; from 20% to 90%; from 20% to 75%; from 20% to 60%; from 20% to 45%; from 20% to 30%; from 20% to 25%; from 25% to 150%; from 25% to 125%; from 25% to 100%; from 25% to 90%; from 25% to 75%; from 25% to 60%; from 25% to 45%; from 25% to 30%; from 40% to 150%; from 40% to 125%; from 40% to 100%; from 40% to 90%; from 40% to 75%; from 40% to 60%; from 40% to 45%; from 55% to 150%; from 55% to 125%; from 55% to 100%; from 55% to 90%; from 55% to 75%; from 55% to 60%; from 70% to 150%; from 70% to 125%; from 70% to 100%; from 70% to 90%; from 70% to 75%; from 90% to 150%; from 90% to 125%; from 90% to 100%; from 100% to 150%; from 100% to 125%; from 125% to 150%; etc.

The inventors have discovered that, surprisingly and unexpectedly, a core slurry containing stucco and starch binder can allow for the inclusion of uncalcined gypsum (e.g., in an amount of at least 25% by weight of the stucco) in the slurry while producing board with good strength. In some embodiments, the starch binder can be an uncooked medium hydrolyzed acid modified starch, which can have a hot water viscosity of from about 20 Brabender Units to about 300 Brabender Units when the viscosity is measured by the hot water viscosity assay (HWVA) method. For example, the uncooked medium hydrolyzed acid modified starch can be in the form of uncooked acid-modified corn starch having a hot water viscosity of 180 BU. Other starches may be used as the starch binder in embodiments of the disclosure, including medium viscosity and medium molecular weight pregelatinized starch, which can have a viscosity from about 35 centipoise to about 425 centipoise when the viscosity is measured according to the VMA method. For example, the pregelatinized starch can have a cold water viscosity of 90 centipoise).

In some embodiments, board produced using uncalcined gypsum in the core slurry has similar or better strength as the same board (at the same weight) prepared without the uncalcined gypsum (i.e., a comparative board). For purposes of such a comparison, it will be understood that the source of calcium sulfate material in the board according to embodiments of the disclosure consists of uncalcined gypsum (e.g., in an amount of at least 20% by weight of the stucco) and stucco, whereas the source of calcium sulfate material of the comparative board consists of stucco without uncalcined gypsum, but that both boards have core slurries with the same amount of calcium sulfate material provided therein.

In embodiments, the starch binder may be uncooked and non-substituted. For example, the uncooked non-substituted starch may comprise of, e.g., tapioca starch, wheat starch, potato starch, and/or corn starch. In embodiments, the uncooked non-substituted starch has a hot water viscosity of from about 30 BU to about 300 BU (e.g., from 30 BU to 200 BU) according to the HWVA method. In some embodiments, the uncooked non-substituted starch has a cold water viscosity of less than about 50 centipoise at 10% solids, as measured according to the BROOKFIELD® viscometer method. In some embodiments, the uncooked non-substituted starch is acid-modified.

The starch binder can be provided in the slurry in any suitable amount. For example, in embodiments, the starch binder is provided in an amount from 2% to 15% by weight of the stucco, such as from 5% to 15%, from 5% to 12%, from 5% to 10%, from 8% to 15%, from 8% to 12%, from 8% to 10%, etc.

In some embodiments, the starch binder can be an uncooked, non-migrating starch or a pregelatinized starch. In some embodiments, the starch includes an uncooked starch having (i) a hot water viscosity of from 20 BU to 300 BU according to the HWVA method, and/or (ii) a mid-range peak viscosity of from 120 BU to 1000 BU according to the HWVA method. Under the HWVA method, the viscosity is measured by putting the starch in a slurry with water at a starch concentration of 15% solids, and using a Viscograph-E instrument set at 75 rpm and 700 cmg, where the starch is heated from 25° C. to 95° C. at a rate of 3° C./minute, the slurry is held at 95° C. for 10 minutes, and the starch is cooled to 50° C. at a rate of −3° C./minute as described in U.S. Pat. No. 10,919,808.

For example, in some embodiments, the starch binder includes an uncooked medium hydrolyzed acid modified starch (e.g., an uncooked acid-modified corn starch having a hot water viscosity of 180 BU according to the HWVA method); and/or a medium viscosity and medium molecular weight pregelatinized starch (e.g., pregelatinized corn flour starch with a cold water viscosity of 90 centipoise according to the VMA method).

Any suitable pregelatinized starch can be included in the core slurry as a starch binder in accordance with embodiments of the disclosure, as described in U.S. Pat. Nos. 10,399,899 and 9,828,441, including methods of preparation thereof and desired viscosity ranges described therein. If included, the pregelatinized starch can exhibit any suitable viscosity. In some embodiments, the pregelatinized starch is a mid-range viscosity starch as measured according to the VMA method as known in the art and as set forth in U.S. Pat. No. 10,399,899, which VMA method is hereby incorporated by reference. In some embodiments, the pregelatinized starch is a pregelatinized partially hydrolyzed starch, wherein the hydrolysis at least partially depolymerizes the starch via acid and/or enzyme modification, wherein the pregelatinized partially hydrolyzed starch has a characteristic of a viscosity from about 35 centipoise to about 425 centipoise when the viscosity is measured while the pregelatinized partially hydrolyzed starch is subjected to conditions according to VMA method. In other embodiments, the pregelatinized starch has a greater viscosity, such as greater than 700 centipoise (e.g., 773 centipoise) according to the VMA test.

Starch binders differ from migrating starches such as LC-211, commercially available from Archer-Daniels-Midland, Chicago, Illinois. Migrating starches normally have smaller chain lengths (e.g., due to acid- or enzyme-modification) and migrate to the core-cover sheet interface for further bond enhancement between the board core and a cover sheet (e.g., paper). For example, in some embodiments, the core slurry includes a migrating starch having a molecular weight of 6,000 Daltons or less to enhance paper-core bond as opposed to being used for binding of uncalcined gypsum since the migrating starch tends to migrate to the paper-core interface.

In accordance with embodiments of the present disclosure, the uncalcined gypsum, starch, and stucco are be added to the gypsum slurry in dry (e.g., powder). In some embodiments, the uncalcined gypsum can be mixed with the stucco before being added to the main mixer for mixing the core slurry. In some embodiments, dry ingredients (e.g., the starch, stucco, and uncalcined gypsum) are mixed, such as by way of a conveyer screw, before being added into the main mixer.

Foaming agent can also be included in the core slurry to provide air voids in the board to reduce weight. The foaming agent can be added by addition in a primary discharge conduit of the main board mixer. In some embodiments, the foaming agent comprises a major weight portion of unstable component, and a minor weight portion of stable component (e.g., where unstable and blend of stable/unstable are combined). The weight ratio of unstable component to stable component is effective to form an air void distribution within the set gypsum core. See, e.g., U.S. Pat. Nos. 5,643,510; 6,342,284; and 6,632,550. It has been found that suitable void distribution and wall thickness can be effective to enhance strength, especially in lower density board (e.g., 35 pcf or less). See, e.g., U.S. Pat. Nos. 9,802,866 and 9,840,066. Evaporative water voids, generally having voids of 5 μm or less in diameter, also contribute to the total void distribution along with the aforementioned air (foam) voids.

Other additives can be included in the core slurry. Such additives include structural additives, including mineral wool, perlite, clay, calcium carbonate, and chemical additives, including fillers, sugar, enhancing agents (such as phosphonates, borates and the like), binders (such as latex), colorants, fungicides, biocides, hydrophobic agent (such as a silicone-based material, including a silane, siloxane, or silicone-resin matrix, e.g.), and the like. Examples of the use of some of these and other additives are described, for instance, in U.S. Pat. Nos. 7,244,304; 7,364,015; 7,803,226; 7,892,472; 6,342,284; 6,632,550; 6,800,131; 5,643,510; 5,714,001; and 6,774,146; and U.S. Patent Application Publication 2002/0045074. Other examples of such additives include fire-rated and/or water resistant product that can also optionally be included in the core slurry, include e.g., siloxanes (water resistance); heat sink additives such as aluminum trihydrate (ATH), magnesium hydroxide or the like; and/or high expansion particles (e.g., expandable to 300% or more of original volume when heated for about one hour at 1560° F.). See, e.g., U.S. Pat. No. 8,323,785 for description of these and other ingredients. In some embodiments, high expansion vermiculite is included, although other fire resistant materials can be included.

The core slurry can include accelerator and/or retarder. Accelerator (e.g., wet gypsum accelerator, heat resistant accelerator, climate stabilized accelerator) and retarder are well known and can be included in the core slurry, if desired. See, e.g., U.S. Pat. Nos. 3,573,947 and 6,409,825. In some embodiments where accelerator and/or retarder are included, the accelerator and/or retarder each can be in the core slurry in an amount on a solid basis of, such as, from 0% to 10% by weight of the stucco (e.g., 0.1% to 10%), such as, for example, from 0% to 5% by weight of the stucco (e.g., 0.1% to 5%).

Polyphosphate can optionally be included in the core slurry, e.g., in order to enhance sag resistance in the board. Trimetaphosphate compounds can be used, including, for example, sodium trimetaphosphate, potassium trimetaphosphate, lithium trimetaphosphate, and ammonium trimetaphosphate.

With respect to the polyphosphate (e.g., sodium trimetaphosphate), the core slurry can include it in any suitable amount, e.g., from 0.01% to 0.5% by weight of the stucco, from 0.01% to 0.4%, from 0.05% to 0.3%, from 0.1% to 0.5%, from 0.1% to 0.4%, from 0.1% to 0.3%, from 0.1% to 0.2%, from 0.15% to 0.5%, from 0.2% to 0.4%, from 0.05% to 0.5%, by weight of the stucco, etc.

Board can be made with different dimensions, depending on, e.g., product type and market. The board can have any suitable width (e.g., 48 inches to 54 inches), length (e.g., 96 inches to 192 inches), and thickness (e.g., ¼ inch, ⅜ inch, ½ inch, ⅝ inch, ¾ inch, 1 inch, etc.). Dimensions in different markets can vary slightly as well understood in the art.

Board weight is a function of the thickness of the board. Since boards are commonly made at varying thicknesses, board density is used herein as a measure of board weight. Examples of suitable nominal thickness include about ¼ inch, about ⅜ inch, about ½ inch, about ⅝ inch, about ¾ inch, or about one inch, and any range using any of the foregoing as endpoints. In some markets, the board can be formed at a nominal thickness according to metric measurements, e.g., about 9 mm, about 9.5 mm, about 10 mm, about 12 mm, about 12.5 mm, about 13 mm, about 15 mm, about 25 mm, and any range using any of the foregoing as endpoints. Properties referenced herein can be seen in board formed at one or more of the previously mentioned board thicknesses according to various embodiments. The advantages of the gypsum board in accordance with embodiments of the disclosure can be seen at a range of densities, including up to heavier board densities, e.g., about 43 pcf or less, or 40 pcf or less, such as from about 17 pcf to about 43 pcf, from about 20 pcf to about 43 pcf, from about 24 pcf to about 43 pcf, from about 27 pcf to about 43 pcf, from about 20 pcf to about 40 pcf, from about 24 pcf to about 40 pcf, from about 27 pcf to about 40 pcf, from about 20 pcf to about 37 pcf, from about 24 pcf to about 37 pcf, from about 27 pcf to about 37 pcf, from about 20 pcf to about 35 pcf, from about 24 pcf to about 35 pcf, from about 27 pcf to about 35 pcf, etc.

The dense layer(s) has a considerably greater density than the density of the board core. For example, the dense layer can have a density of from 40 pcf to 70 pcf (e.g., from 45 pcf to 65 pcf, or from 50 pcf to 60 pcf).

The core can have any suitable density but lesser densities can be used, e.g., a core density of 35 pcf or less (e.g., 31 pcf or less, or 27 pcf or less). For example, the core can have a density of from 15 pcf to 35 pcf (e.g., from 20 pcf to 31 pcf, from 20 pcf to 24 pcf, or from 24 pcf to 27 pcf, etc.).

The board can be prepared in any suitable manner. In embodiments, a main mixer containing an agitator as understood in the art is used at a wet end of a manufacturing line as also understood in the art. The agitator can be in the form of pins, disk, impeller, propeller, rotor spinning inside a stationary housing, or the like. The main mixer can be used to prepare a core and dense slurry, respectively. Stucco, water, and optionally, an additive package are inserted into the main mixer. The mixer contains a primary discharge conduit and a secondary discharge conduit. Slurry is discharged from the primary discharge conduit where core additives such as foam (see, e.g., U.S. Pat. No. 5,683,635) are inserted to form a core slurry. Slurry can be released from the secondary discharge conduit to form a dense layer slurry (e.g., with less or no foaming agent as compared with the core slurry).

A first moving cover sheet (e.g., over a moving conveyor) is provided. The board is generally formed upside down at the wet end of the plant such that the first moving cover sheet is generally the face cover sheet, although this is not mandatory. The dense layer slurry is deposited over the moving cover sheet. The core slurry is deposited over the dense layer. A second moving cover sheet (e.g., the back paper) is applied over the core slurry layer to form a sandwich structure of a board precursor. In embodiments, the dense layer slurry is deposited onto the moving cover sheet upstream of the mixer, while the core slurry is deposited over the cover sheet bearing the dense layer, downstream of the mixer. In some embodiments, the secondary discharge conduit is disposed on the mixer upstream of the primary discharge conduit to conveniently accommodate this arrangement of depositing the layers relative to the positioning of the mixer.

If desired, it will be understood that the board can be prepared using two separate mixers equipped with agitators, with one mixer dedicated for preparing the core slurry and the other mixer dedicated for preparing the core slurry. As such, each of the dense layer and core slurries can be separately formulated and discharged out of each mixer and then applied to form the board as described herein.

After the sandwich structure of the board precursor is formed at the wet end of the manufacturing line, the board precursor sets as it travels, e.g., by conveyor, to other stations, including a knife, where the board precursor is cut into segments. The board can then be flipped and dried in a kiln to form the final board product and processed at the dry end of the manufacturing line, e.g., to a final size, as understood by one of ordinary skill in the art. Arrangements for producing the board are described in, e.g., U.S. Pat. Nos. 5,683,635; 6,494,609; 6,874,930; and 7,364,676 and U.S. Patent Application Publications 2010/0247937; 2012/0168527; and 2012/0170403.

The disclosure is further illustrated by the following exemplary aspects. However, the disclosure is not limited by the following aspects.

(1) A gypsum board, slurry, or method of preparing board, as described herein.

(2) A gypsum board comprising: a set gypsum core disposed between two cover sheets, the core formed from a slurry comprising water, uncalcined gypsum, stucco, and starch binder; the starch binder comprising (a) at least one uncooked non-substituted starch having a hot water viscosity of from about 20 Brabender Units to about 300 Brabender Units when the viscosity is measured by the HWVA method, (b) at least one pregelatinized starch, or (c) a combination of (a) and (b).

(3) The gypsum board of aspect 2, wherein the weight ratio of stucco to uncalcined gypsum is from 3:1 to 1:2, such as from 2:1 to 1:1.5, or from 1.5:1 to 1:1.5.

(4) The gypsum board of aspects 2 or 3, wherein the uncalcined gypsum is provided in the slurry in an amount from 25% to 150% by weight of the stucco, such as from 30% to 100%, or from 40% to 100%.

(5) The gypsum board of any one of aspects 2-4, wherein the starch binder is provided in the slurry in an amount from 2% to 15% by weight of the stucco, such as from 5% to 15%, from 5% to 12%, or from 8% to 10%.

(6) The gypsum board of any one of aspects 2-5, wherein board has a density of less than 40 pcf, such as from 27 to 33 pcf, from 28 to 32 pcf, or from 29 to 31 pcf.

(7) The gypsum board of any one of aspects 2-6, wherein the board has a nail pull resistance of at least 72 pounds according to ASTM 473-10 and/or a core hardness of at least 11 pounds as determined according to ASTM 473-10.

(8) The gypsum board of any one of aspects 2-7, wherein the slurry has a water/stucco ratio of less than 1.0, such as from 0.6 to 0.9, or from 0.7 to 0.8.

(9) The gypsum board of any one of aspects 2-8, wherein the stucco is provided in the slurry in an amount of 800 lbs/MSF or less, such as from 500 to 700 lbs/MSF, or from 550 to 650 lbs/MSF.

(10) The gypsum board of any one of aspects 2-9, wherein the water is provided in the slurry in an amount of 1000 lbs/MSF or less, such as from 600 lbs/MSF to 800 lbs/MSF, or from 700 lbs/MSF to 800 lbs/MSF.

(11) The gypsum board of any one of aspects 2-10, wherein the uncalcined gypsum has an average particle size from 20 μm to 1000 μm, such as from 20 μm to 500 μm, or from 20 μm to 100 μm.

(12) The gypsum board of any one of aspects 2-11, wherein the uncooked non-substituted starch is tapioca starch, wheat starch, potato starch, and/or corn starch.

(13) The gypsum board of any one of aspects 2-12, wherein the uncooked non-substituted starch has a hot water viscosity of from about 30 BU to about 300 BU.

(14) The gypsum board of any one of aspects 2-13, wherein the uncooked non-substituted starch is acid-modified.

(15) The gypsum board of any one of aspects 2-14, wherein the uncooked non-substituted starch has a cold water viscosity of less than about 50 centipoise at 10% solids, as measured according to the BROOKFIELD® viscometer method.

(16) The gypsum board of any one of aspects 2-15, wherein the pregelatinized starch is a pregelatinized partially hydrolyzed starch, wherein the hydrolysis at least partially depolymerizes the starch via acid and/or enzyme modification, wherein the pregelatinized partially hydrolyzed starch has a characteristic of a viscosity from about 35 centipoise to about 425 centipoise when the viscosity is measured while the pregelatinized partially hydrolyzed starch is subjected to conditions according to VMA method.

(17) A method of making gypsum board, the method comprising: mixing a slurry comprising water, uncalcined gypsum, a stucco, and a starch binder, the starch binder comprising (a) at least one uncooked non-substituted starch having a hot water viscosity of from about 20 Brabender Units to about 300 Brabender Units when the viscosity is measured by the HWVA method, (b) at least one pregelatinized starch, or (c) a combination of (a) and (b); placing the slurry between two cover sheets to form a board precursor; allowing the slurry in the precursor to set to form the board; and cutting the board.

(18) The method of aspect 17, wherein the weight ratio of stucco to uncalcined gypsum is from 3:1 to 1:2, such as from 2:1 to 1:1.5, or from 1.5:1 to 1:1.5.

(19) The method of aspects 17 or 18, wherein the uncalcined gypsum is provided in the slurry in an amount from 25% to 150% by weight of the stucco, such as from 30% to 100%, or from 40% to 100%.

(20) The method of any one of aspects 17-19, wherein the starch binder is provided in the slurry in an amount from 2% to 15% by weight of the stucco, such as from 5% to 15%, from 5% to 12%, or from 8% to 10%.

(21) The method of any one of aspects 17-20, wherein board has a density of less than 40 pcf, such as from 27 to 33 pcf, from 28 to 32 pcf, or from 29 to 31 pcf.

(22) The method of any one of aspects 17-21, wherein the board has a nail pull resistance of at least 72 pounds according to ASTM 473-10 and/or a core hardness of at least 11 pounds as determined according to ASTM 473-10.

(23) The method of any one of aspects 17-22, wherein the slurry has a water/stucco ratio of less than 1.0, such as from 0.5 to 0.9, or from 0.6 to 0.85.

(24) The method of any one of aspects 17-23, wherein the stucco is provided in the slurry in an amount of 800 lbs/MSF or less, such as from 500 to 700 lbs/MSF, or from 5550 to 650 lbs/MSF.

(25) The method of any one of aspects 17-24, wherein the water is provided in the slurry in an amount of 1000 lbs/MSF or less, such as from 600 to 800 lbs/MSF, or from 700 to 800 lbs/MSF.

(26) The method of any one of aspects 17-25, wherein the uncalcined gypsum has an average particle size from 20 μm to 1000 μm, such as from 20 μm to 500 μm, or from 20 μm to 100 μm.

(27) The method of any one of aspects 17-26, wherein the uncooked non-substituted starch is tapioca starch, wheat starch, potato starch, and/or corn starch.

(28) The method of any one of aspects 17-27, wherein the uncooked non-substituted starch has a hot water viscosity of from about 30 BU to about 200 BU.

(29) The method of any one of aspects 17-28, wherein the uncooked non-substituted starch is acid-modified.

(30) The method of any one of aspects 17-29, wherein the uncooked non-substituted starch has a cold water viscosity of less than about 50 centipoise at 10% solids, as measured according to the BROOKFIELD® viscometer method.

(31) The method of any one of aspects 17-30, wherein the pregelatinized starch is a pregelatinized partially hydrolyzed starch, wherein the hydrolysis at least partially depolymerizes the starch via acid and/or enzyme modification, wherein the pregelatinized partially hydrolyzed starch has a characteristic of a viscosity from about 35 centipoise to about 425 centipoise when the viscosity is measured while the pregelatinized partially hydrolyzed starch is subjected to conditions according to VMA method.

(32) A gypsum board comprising: a set gypsum core disposed between two cover sheets, the core formed from a slurry comprising water, uncalcined gypsum, stucco, and starch binder; the starch binder comprising (a) at least one uncooked non-substituted starch having a hot water viscosity of from about 20 Brabender Units to about 300 Brabender Units when the viscosity is measured by the HWVA method, (b) at least one pregelatinized starch, or (c) a combination of (a) and (b); wherein the uncalcined gypsum is provided in the slurry in an amount from 25% to 150% by weight of the stucco, such as from 30% to 100%, from 40% to 100%, from 50% to 100%, from 60% to 100%, from 70% to 100%, from 80% to 100%, from 90% to 100%, from 20% to 90%, from 20% to 80%, from 20% to 70%, or from 25% to 50%; wherein the starch binder is provided in the slurry in an amount from 2% to 15% by weight of the stucco, such as from 5% to 15%, from 5% to 12%, or from 8% to 10%; wherein the slurry has a water/stucco ratio of less than 1.0, such as from 0.3 to 1.0, from 0.5 to 0.9, or from 0.6 to 0.85; and wherein the board has a nail pull resistance of at least 72 pounds according to ASTM 473-10, such as from 72 pounds to 120 pounds, from 72 pounds to 115 pounds, from 72 pounds to 110 pounds, from 72 pounds to 105 pounds, from 72 pounds to 100 pounds, from 72 pounds to 90 pounds, or from 72 pounds to 80 pounds, and/or a core hardness of at least 11 pounds as determined according to ASTM 473-10, such as from 11 pounds to 35 pounds, from 11 pounds to 30 pounds, 11 pounds to 25 pounds, 11 pounds to 20 pounds, or 11 pounds to 15 pounds.

(33) The gypsum board of aspect 32, wherein the weight ratio of stucco to uncalcined gypsum is from 3:1 to 1:2, such as from 2:1 to 1:1.5, or from 1.5:1 to 1:1.5.

(34) The gypsum board of aspects 32 or 33, wherein board has a density of less than 40 pcf, such as from 25 to 38 pcf, from 25 to 35 pcf, from 25 to 32 pcf, from 25 to 30 pcf, from 27 to 38 pcf, from 27 to 35 pcf, from 27 to 32 pcf, from 27 to 30 pcf, from 30 to 38 pcf, from 30 to 35 pcf, from 30 to 32 pcf, from 28 to 32 pcf, or from 29 to 31 pcf.

(35) The gypsum board of any one of aspects 32-34, wherein the stucco is provided in the slurry in an amount of 800 lbs/MSF or less, such as from 500 to 700 lbs/MSF, or from 550 to 650 lbs/MSF.

(36) The gypsum board of any one of aspects 32-35, wherein the water is provided in the slurry in an amount of 1000 lbs/MSF or less, such as from 600 lbs/MSF to 800 lbs/MSF, or from 700 lbs/MSF to 800 lbs/MSF.

(37) The gypsum board of any one of aspects 32-36, wherein the uncalcined gypsum has an average particle size from 20 μm to 1000 μm, such as from 20 μm to 500 μm, or from 20 μm to 100 μm.

(38) The gypsum board of any one of aspects 32-37, wherein the uncooked non-substituted starch is tapioca starch, wheat starch, potato starch, and/or corn starch.

(39) The gypsum board of any one of aspects 32-38, wherein the uncooked non-substituted starch has a hot water viscosity of from about 30 BU to about 300 BU.

(40) The gypsum board of any one of aspects 32-39, wherein the uncooked non-substituted starch is acid-modified.

(41) The gypsum board of any one of aspects 32-40, wherein the uncooked non-substituted starch has a cold water viscosity of less than about 50 centipoise at 10% solids, as measured according to the BROOKFIELD® viscometer method.

(42) The gypsum board of any one of aspects 32-41, wherein the pregelatinized starch is a pregelatinized partially hydrolyzed starch, wherein the hydrolysis at least partially depolymerizes the starch via acid and/or enzyme modification, wherein the pregelatinized partially hydrolyzed starch has a characteristic of a viscosity from about 35 centipoise to about 425 centipoise when the viscosity is measured while the pregelatinized partially hydrolyzed starch is subjected to conditions according to VMA method.

(43) A method of making gypsum board, the method comprising: mixing a slurry comprising water, uncalcined gypsum, a stucco, and a starch binder, the starch binder comprising (a) at least one uncooked non-substituted starch having a hot water viscosity of from about 20 Brabender Units to about 300 Brabender Units when the viscosity is measured by the HWVA method, (b) at least one pregelatinized starch, or (c) a combination of (a) and (b); wherein the uncalcined gypsum is provided in the slurry in an amount from 25% to 150% by weight of the stucco, such as from 30% to 100%, from 40% to 100%, from 50% to 100%, from 60% to 100%, from 70% to 100%, from 80% to 100%, from 90% to 100%, from 20% to 90%, from 20% to 80%, from 20% to 70%, or from 25% to 50%; wherein the starch binder is provided in the slurry in an amount from 2% to 15% by weight of the stucco, such as from 5% to 15%, from 5% to 12%, or from 8% to 10%; and wherein the slurry has a water/stucco ratio of less than 1.0, such as from 0.3 to 1.0, from 0.5 to 0.9, or from 0.6 to 0.85; placing the slurry between two cover sheets to form a board precursor; allowing the slurry in the precursor to set to form the board; and cutting the board; wherein the board has a nail pull resistance of at least 72 pounds according to ASTM 473-10, such as from 72 pounds to 120 pounds, from 72 pounds to 115 pounds, from 72 pounds to 110 pounds, from 72 pounds to 105 pounds, from 72 pounds to 100 pounds, from 72 pounds to 90 pounds, or from 72 pounds to 80 pounds, and/or a core hardness of at least 11 pounds as determined according to ASTM 473-10, such as from 11 pounds to 35 pounds, from 11 pounds to 30 pounds, 11 pounds to 25 pounds, 11 pounds to 20 pounds, or 11 pounds to 15 pounds.

(44) The method of aspect 43, wherein the weight ratio of stucco to uncalcined gypsum is from 3:1 to 1:2, such as from 2:1 to 1:1.5, or from 1.5:1 to 1:1.5.

(45) The method of aspects 43 or 44, wherein board has a density of less than 40 pcf, such as from 27 to 33 pcf, from 28 to 32 pcf, or from 29 to 31 pcf.

(46) The method of any one of aspects 43-45, wherein the stucco is provided in the slurry in an amount of 800 lbs/MSF or less, such as from 500 to 700 lbs/MSF, or from 550 to 650 lbs/MSF.

(47) The method of any one of aspects 43-46, wherein the water is provided in the slurry in an amount of 1000 lbs/MSF or less, such as from 600 lbs/MSF to 800 lbs/MSF, or from 700 lbs/MSF to 800 lbs/MSF.

(48) The method of any one of aspects 43-47, wherein the uncalcined gypsum has an average particle size from 20 μm to 1000 μm, such as from 20 μm to 500 μm, or from 20 μm to 100 μm.

(49) The method of any one of aspects 43-48, wherein the uncooked non-substituted starch is tapioca starch, wheat starch, potato starch, and/or corn starch.

(50) The method of any one of aspects 43-49, wherein the uncooked non-substituted starch has a hot water viscosity of from about 30 BU to about 300 BU.

(51) The method of any one of aspects 43-50, wherein the uncooked non-substituted starch is acid-modified.

(52) The method of any one of aspects 43-51, wherein the uncooked non-substituted starch has a cold water viscosity of less than about 50 centipoise at 10% solids, as measured according to the BROOKFIELD® viscometer method.

(53) The method of any one of aspects 43-52, wherein the pregelatinized starch is a pregelatinized partially hydrolyzed starch, wherein the hydrolysis at least partially depolymerizes the starch via acid and/or enzyme modification, wherein the pregelatinized partially hydrolyzed starch has a characteristic of a viscosity from about 35 centipoise to about 425 centipoise when the viscosity is measured while the pregelatinized partially hydrolyzed starch is subjected to conditions according to VMA method.

(54) A slurry comprising: water, uncalcined gypsum, stucco, and starch binder; the starch binder comprising (a) at least one uncooked non-substituted starch having a hot water viscosity of from about 20 Brabender Units to about 300 Brabender Units when the viscosity is measured by the HWVA method, (b) at least one pregelatinized starch, or (c) a combination of (a) and (b); wherein the uncalcined gypsum is provided in the slurry in an amount from 25% to 150% by weight of the stucco, such as from 30% to 100%, from 40% to 100%, from 50% to 100%, from 60% to 100%, from 70% to 100%, from 80% to 100%, from 90% to 100%, from 20% to 90%, from 20% to 80%, from 20% to 70%, or from 25% to 50%; wherein the starch binder is provided in the slurry in an amount from 2% to 15% by weight of the stucco, such as from 5% to 15%, from 5% to 12%, or from 8% to 10%; and wherein the slurry has a water/stucco ratio of less than 1.0, such as from 0.3 to 1.0, from 0.5 to 0.9, or from 0.6 to 0.85.

(55) The slurry of aspect 54, wherein the weight ratio of stucco to uncalcined gypsum is from 3:1 to 1:2, such as from 2:1 to 1:1.5, or from 1.5:1 to 1:1.5.

(56) The slurry of aspects 54 or 55, wherein the stucco is provided in the slurry in an amount of 800 lbs/MSF or less, such as from 500 to 700 lbs/MSF, or from 550 to 650 lbs/MSF.

(57) The slurry of any one of aspects 54-56, wherein the water is provided in the slurry in an amount of 1000 lbs/MSF or less, such as from 600 lbs/MSF to 800 lbs/MSF, or from 700 lbs/MSF to 800 lbs/MSF.

(58) The slurry of any one of aspects 54-57, wherein the uncalcined gypsum has an average particle size from 20 μm to 1000 μm, such as from 20 μm to 500 μm, or from 20 μm to 100 μm.

(59) The slurry of any one of aspects 54-58, wherein the uncooked non-substituted starch is tapioca starch, wheat starch, potato starch, and/or corn starch.

(60) The slurry of any one of aspects 54-59, wherein the uncooked non-substituted starch has a hot water viscosity of from about 30 BU to about 300 BU.

(61) The slurry of any one of aspects 54-60, wherein the uncooked non-substituted starch is acid-modified.

(62) The slurry of any one of aspects 54-61, wherein the uncooked non-substituted starch has a cold water viscosity of less than about 50 centipoise at 10% solids, as measured according to the BROOKFIELD® viscometer method.

(63) The slurry of any one of aspects 54-62, wherein the pregelatinized starch is a pregelatinized partially hydrolyzed starch, wherein the hydrolysis at least partially depolymerizes the starch via acid and/or enzyme modification, wherein the pregelatinized partially hydrolyzed starch has a characteristic of a viscosity from about 35 centipoise to about 425 centipoise when the viscosity is measured while the pregelatinized partially hydrolyzed starch is subjected to conditions according to VMA method.

It shall be noted that the preceding aspects are illustrative and not limiting. Other exemplary combinations are apparent from the entirety of the description herein. It will also be understood by one of ordinary skill in the art that various embodiments may be used in various combinations with the other embodiments provided herein.

The following examples further illustrate the disclosure but, of course, should not be construed as in any way limiting its scope.

### EXAMPLE 1

This example demonstrates the effect of replacing 30% of stucco with uncalcined gypsum in gypsum slurries according to principles of embodiments of the disclosure. To measure the impact such replacement would have on slump and stiffening measurements, the fluidity was measured according to the slump fluidity spread (SFS) test (see also U.S. Pat. No. 10,968,138) and the stiffening test as described herein.

Two gypsum slurries, labeled as Slurries 1A and 1B, were prepared. For each of Slurries 1A and 1B, the respective slurries contained an amount of stucco, dispersant, and water. In particular, the acid-modified starch was provided in the form of an uncooked acid-modified corn starch having a hot water viscosity of 180 BU. Slurry 1A had a water to solids ratio of 0.9, while Slurry 1B had a water to solids ratio of 0.75. Slurry 1B was prepared from a slurry comprising 30% of uncalcined gypsum as a replacement for that portion of stucco (referred to hereinafter as the “30% replacement slurry”). Slurry 1B further comprised uncooked medium hydrolyzed acid modified starch, which can be selected from a hot water viscosity of from about 20 Brabender Units to about 300 Brabender Units when the viscosity is measured by the HWVA method. Slurry 1A was prepared as a control with pregelatinized starch. The pregelatinized starch is a medium viscosity and medium molecular weight pregelatinized starch, which can be selected from a viscosity from about 35 centipoise to about 425 centipoise when the viscosity is measured while the pregelatinized partially hydrolyzed starch is subjected to conditions according to VMA method. In particular, the pregelatinized starch was provided in the form of pregelatinized corn flour starch with a cold water viscosity of 90 centipoise.

In order to form each of the slurries, the dry ingredients and aqueous solution were initially combined in a laboratory Waring blender. The mixture was then allowed to soak for 10 seconds. Once soaked, the mixture was then mixed at high speed for 10 seconds in order to produce the slurry.

The slurries were then tested in accordance with the SFS test and stiffening test. As referred to herein, the SFS test is conducted in the following manner. Briefly, a 2″ (about 5 cm) diameter tube (e.g., with two open ends, one resting on a flat, substantially non-porous surface so as to block the opening) is filled with slurry to a height of 4″ (about 10 cm). Within 5 seconds from sampling and pouring the slurry, the slurry is released onto a flat, level surface by quickly lifting the cylinder, and the released slurry is allowed to spread into a patty. When the slurry has stopped spreading, the widest diameter of the slurry patty (i.e., referred to as the “slump”) is measured (in the case of non-circular (e.g., elliptical) slurry patty, the widest diameter of the slurry patty is averaged with the diameter of the slurry patty in the direction perpendicular to the widest diameter). In some embodiments, a more fluid slurry will typically result in a larger diameter slurry patty.

Gypsum slurries, in accordance with embodiments of the disclosure, can produce patties having any suitable diameter when subjected to the SFS test. By way of example, and not limitation, in some embodiments, the slurry can produce a patty in a range of 4 inches (in) to 10 in, e.g., 4.5 to 10 in; 5 to 10 in; 5.5 to 10 in; 6 to 10 in; 6.5 to 10 in; 7 to 10 in; 7.5 to 10 in; 8 to 10 in; 8.5 to 10 in; 9 to 10 in; 9.5 to 10 in; 6.5 to 8.5 in; 6.5 in to 7.5 in; 6.5 in to 7 in; 7 in to 8.5 in; 7.5 in to 8.5 in, 8 in to 8.5 in; etc.

The performance of Slurries 1A and 1B was measured by targeting the same target for all tests: 7″-8″ diameter patty as measured in accordance with the SFS test and approximately 45 seconds stiffening time. In order to ensure similar SFS results, the total water content was adjusted for Slurries 1A and 1B until a diameter of 7″-8″ was achieved. The differences in water-demand to achieve these performance benchmarks were measured.

The stiffening test was also performed to measure the properties of the slurries. As referred to herein, to measure the stiffening rate, a test is conducted to record the stiffening rate of each slurry patty. To measure the stiffening properties, each patty is “cut” with a needle. To perform a cut, a needle is inserted through the patty until the tip of the needles reaches the testing surface (e.g., a table). Subsequent cuts are administered every second until the opening created in the slurry patty is no longer “healed” (e.g., no longer closes). The time taken to administer the test is then recorded (in seconds).

Table 1 depicts the formulations of Slurries 1A-1B. Table 2 depicts the water demand of the 30% replacement slurry as measured by the stiffening and SFS test results of each of Slurries 1A and 1B.

TABLE 1

| | Slurry 1A | Slurry 1B |
|---|---|---|
| Ingredient | (Control) | (30% Replacement Slurry) |
| Water to Solids Ratio | 0.9 | 0.75 |
| Stucco (g) | 300 | 210 |
| Uncalcined Gypsum | 0 | 90 |
| (Land Plaster) (g) | | |
| Accelerator | 3 | 3 |
| Pregelatinized corn flour | 2.4 | 0 |
| starch with a cold water | | |
| viscosity of 90 centipoise (g) | | |
| Uncooked acid-modified corn | 0 | 30 |
| starch having a hot water | | |
| viscosity of 180 BU (g) | | |
| Dispersant (g) | 0.065 | 0.05 |
| Water (g) | 268 | 224 |

TABLE 2

| | Slurry 1A | Slurry 1B |
|---|---|---|
| Test Result | (Control) | (30% Replacement Slurry) |
| Slump (in) | 7⅝ | 7½ |
| Stiffening (s) | 44 | 42 |

As seen in Tables 1 and 2, Slurry 1B reduced water to solids ratio from 0.90 to 0.75, without changing the slurry workability, as indicated by the comparable slump and stiffening results. This is significant because less energy is required to dry off the excess water.

### EXAMPLE 2

This example demonstrates exemplary benefits of including 30% replacement slurry in gypsum compositions according to principles of embodiments of the disclosure.

Three boards were prepared and tested, identified below as Boards 2A, 2B and 2C, respectively. Control Board 2A was prepared from a slurry comprising calcined gypsum, accelerator, pregelatinized starch, sodium trimetaphosphate, dispersant, retarder, and water. The pregelatinized starch can be a medium viscosity and medium molecular weight pregelatinized starch, which can have a viscosity from about 35 centipoise to about 425 centipoise when the viscosity is measured while the pregelatinized partially hydrolyzed starch is subjected to conditions according to VMA method. In particular, the pregelatinized starch was provided in the form of pregelatinized corn flour starch with a cold water viscosity of 90 centipoise. Board 2A was prepared as a control, i.e., without the replacement of any stucco with uncalcined gypsum (i.e., 100% of the calcium sulfate material provided in the core slurry consists of calcined gypsum, i.e., stucco). Both Boards 2B and 2C replaced 30% of the calcined gypsum (i.e., stucco) with uncalcined gypsum (i.e., land plaster). In addition, Boards 2B and 2C were prepared from slurries comprising uncooked medium hydrolyzed acid modified starch, which can have a hot water viscosity of from about 20 Brabender Units to about 300 Brabender Units when the viscosity is measured by the HWVA method. In particular, the acid-modified starch was provided in the form of an uncooked acid-modified corn starch having a hot water viscosity of 180 BU. Board 2B was prepared from a slurry comprising of 9.6% by weight of uncooked acid-modified corn starch having a hot water viscosity of 180 BU. Board 2C was prepared from a slurry comprising of 7.6% by weight of uncooked acid-modified corn starch having a hot water viscosity of 180 BU.

To prepare the boards, Boards 2A-2C were initially heated at 430° F. for 8 minutes. Then, Boards 2A-2C were heated at 375° F. for 11 minutes. Boards 2A-2C were then dried at 110° F. overnight.

Table 3 depicts the formulations of the slurries from which Boards 2A-2C were prepared.

TABLE 3

| | Board 2A (control) | | Board 2B | | Board 2C | |
|---|---|---|---|---|---|---|
| | | % of the | | % of the | | % of the |
| | | total | | total | | total |
| Ingredient | Lbs/msf | gypsum | Lbs/msf | gypsum | Lbs/msf | gypsum |
| Calcined Gypsum | 1020 | 100 | 671 | 70.0 | 708 | 70.0 |
| Uncalcined Gypsum | 0 | 0.00 | 287 | 30.0 | 304 | 30.0 |
| Accelerator | 10 | 0.98 | 9.1 | 0.9 | 9.1 | 0.9 |
| Pregelatinized corn | 8.2 | 0.80 | 0 | 0.0 | 0 | 0.0 |
| flour starch with a cold | | | | | | |
| water viscosity of 90 | | | | | | |
| centipoise | | | | | | |
| Uncooked acid- | 0 | 0.00 | 92 | 9.6 | 77 | 7.6 |
| modified corn starch | | | | | | |
| having a hot water | | | | | | |
| viscosity of 180 BU | | | | | | |
| Sodium | 2 | 0.20 | 2 | 0.2 | 2 | 0.2 |
| Trimetaphosphate | | | | | | |
| Dispersant | 5 | 0.49 | 5 | 0.5 | 5 | 0.5 |
| Retarder | 0.2 | 0.020 | 0.2 | 0.0 | 0.2 | 0.02 |
| Total Water | 918 | 90 | 766 | 80.9 | 772 | 76.3 |

As seen in Table 3, the total water used by Boards 2B and 2C is lower than that of the control, Board 2A. Specifically, the total water used for Board 2B was 766 lbs/msf (80.9% of the total gypsum), while the total water used for Board 2C was 772 lbs/msf (76.3% of the total gypsum), as compared to the water use of Board 2A (918 lbs/msf, or 90% of the total gypsum). This is significant because less energy was used to make wallboard.

Table 4 depicts the nail pull strength results of Boards 2A-2C.

TABLE 4

| Ingredient | Board 2A (Control) | Board 2B | Board 2C |
|---|---|---|---|
| Board weight | 1305 | 1261 | 1309 |
| (lbs/msf) | | | |
| Nail Pull Strength | 77.5 | 84.2 | 78.2 |
| (lbs) | | | |

Table 3 shows Board 2B reduced stucco from 1020 lbs/msf to 671 lbs/msf, reduced total water from 918 lbs/msf to 766 lbs/msf. As seen in Table 4, Board 2B had 84.2 lbs nail pull at a board weight of 1261 lbs/msf, compared to the Control Board A with 77.5 lbs nail pull at a board weight of 1305 lbs/msf. Board 2C reduced stucco from 1020 lbs/msf to 708 lbs/msf and reduced total water from 918 lbs/msf to 772 lbs/msf. Board C had 78.2 lbs nail pull at a board weight of 1309 lbs/msf, compared to the Control Board A with 77.5 lbs nail pull at a board weight of 1305 lbs/msf. Both Board 2B and 2C reduced calcined gypsum and total water usage without affecting the board nail pull strength. This is significant because less energy was used to make the wallboard.

### EXAMPLE 3

This example demonstrates exemplary benefits of including 40% replacement slurry in gypsum compositions according to principles of embodiments of the disclosure.

Two boards were prepared and tested, identified below as Boards 3A and 3B, respectively. Control Board 3A was prepared from a slurry comprising calcined gypsum, accelerator, pregelatinized starch, sodium trimetaphosphate, dispersant, retarder, and water. The pregelatinized starch can be a medium viscosity and medium molecular weight pregelatinized starch, which can have a viscosity from about 35 centipoise to about 425 centipoise when the viscosity is measured while the pregelatinized partially hydrolyzed starch is subjected to conditions according to VMA method. In particular, the pregelatinized starch was provided in the form of pregelatinized corn flour starch with a cold water viscosity of 90 centipoise. Board 3A was prepared as a control, i.e., without the replacement of any stucco with uncalcined gypsum (i.e., 100% of the calcium sulfate material provided in the core slurry consists of calcined gypsum, i.e., stucco). Board 3B replaced 40% of the calcined gypsum (i.e., stucco) with uncalcined gypsum (i.e., land plaster). In addition, Board 3B were prepared from a slurry comprising uncooked medium hydrolyzed acid modified starch. The uncooked medium hydrolyzed acid-modified starch can have a hot water viscosity of from about 20 Brabender Units to about 300 Brabender Units when the viscosity is measured by the HWVA method. In particular, Board 3B was prepared from a slurry comprising 10% by weight of uncooked acid-modified corn starch having a hot water viscosity of 180 BU.

To prepare the boards, Boards 3A and 3B were initially heated at 430° F. for 8 minutes. Then, Boards 3A and 3B were heated at 375° F. for 11 minutes. Boards 3A and 3B were then dried at 110° F. overnight.

Table 5 depicts the formulations of the slurries from which Boards 3A and 3B were prepared.

TABLE 5

| | Board 3A (Control) | | Board 3B | |
|---|---|---|---|---|
| | | % of the | | % of the |
| | | total | | total |
| Ingredient | Lbs/msf | gypsum | Lbs/msf | gypsum |
| Calcined Gypsum | 1020 | 100 | 610 | 60.0 |
| Uncalcined Gypsum | 0 | 0.00 | 406 | 40.0 |
| Accelerator | 10 | 0.98 | 9.6 | 0.9 |
| Pregelatinized corn | 8.2 | 0.80 | 0 | 0.0 |
| flour starch with a cold | | | | |
| water viscosity of 90 | | | | |
| centipoise | | | | |
| Uncooked acid- | 0 | 0.00 | 102 | 10.0 |
| modified corn starch | | | | |
| having a hot water | | | | |
| viscosity of 180 BU | | | | |
| Sodium | 2 | 0.20 | 2 | 0.20 |
| Trimetaphosphate | | | | |
| Dispersant | 5 | 0.49 | 5 | 0.5 |
| Retarder | 0.2 | 0.02 | 0.2 | 0.02 |
| Total Water | 918 | 90 | 762 | 75.0 |

As seen in Table 5, the total water used by Board 3B is lower than that of the control, Board 3A. Specifically, the total water used for Board 3B was 762 lbs/msf (75% of the total gypsum) as compared to the water use of Board 3A (918 lbs/msf, or 90% of the total gypsum). This is significant because less energy was used to make the wallboard.

Table 6 depicts the stucco, water usage, and nail pull strength results of Boards 3A and 3B.

TABLE 6

| Ingredient | Board 3A (Control) | Board 3B |
|---|---|---|
| Board Weight (lbs/msf) | 1305 | 1320 |
| Nail Pull Strength | 77.5 | 79.9 |

As seen in Table 6, Board 3B reduced stucco from 1020 lbs/msf to 610 lbs/msf, reduced total water from 918 lbs/msf to 762 lbs/msf. Board 3B had 79.9 lbs nail pull at a board weight of 1320 lbs/msf, compared to the Board 3A with 77.5 lbs nail pull at a board weight of 1305 lbs/msf. This is significant because less energy was used to make the wallboard.

### EXAMPLE 4

This example demonstrates exemplary benefits of including 60% replacement slurry in gypsum compositions according to principles of embodiments of the disclosure.

Two boards were prepared and tested, identified below as Boards 4A and 4B, respectively. Control Board 4A was prepared from a slurry comprising calcined gypsum, accelerator, pregelatinized starch, sodium trimetaphosphate, dispersant, retarder, and water. The pregelatinized starch can be a medium viscosity and medium molecular weight pregelatinized starch, which can have a viscosity from about 35 centipoise to about 425 centipoise when the viscosity is measured while the pregelatinized partially hydrolyzed starch is subjected to conditions according to VMA method. In particular, the pregelatinized starch was provided in the form of pregelatinized corn flour starch with a cold water viscosity of 90 centipoise. Board 4A was prepared as a control, i.e., without the replacement of any stucco with uncalcined gypsum (i.e., 100% of the calcium sulfate material provided in the core slurry consists of calcined gypsum, i.e., stucco). Board 4B replaced 60% of the calcined gypsum (i.e., stucco) with uncalcined gypsum (i.e., land plaster). Further, Board 4B was prepared from a slurry comprising uncooked medium hydrolyzed acid modified starch. The uncooked medium hydrolyzed acid-modified starch can have a hot water viscosity of from about 20 Brabender Units to about 300 Brabender Units when the viscosity is measured by the HWVA method. In particular, Board 4B was prepared from a slurry comprising 9% by weight of uncooked acid-modified corn starch having a hot water viscosity of 180 BU. In addition, Board 4B was prepared from a slurry comprising polyvinyl alcohol (PVA) (1% by weight) and paper fiber (1% by weight) to improve the wet strength of the board.

To prepare the boards, Boards 4A and 4B were initially heated at 430° F. for 8 minutes. Then, Boards 4A and 4B were heated at 375° F. for 11 minutes. Boards 4A and 4B were then dried at 110° F. overnight.

Table 7 depicts the formulations of the slurries from which Boards 4A and 4B were prepared.

TABLE 7

| | Board 4A (Control) | | Board 4B | |
|---|---|---|---|---|
| | | % of the | | % of the |
| | | total | | total |
| Ingredient | Lbs/msf | gypsum | Lbs/msf | gypsum |
| Calcined Gypsum | 1020 | 100 | 536 | 40.0 |
| Uncalcined Gypsum | 0 | 0.00 | 804 | 60.0 |
| Accelerator | 10 | 0.98 | 12 | 0.9 |
| Pregelatinized corn | 8.2 | 0.90 | 0 | 0.0 |
| flour starch with a cold | | | | |
| water viscosity of 90 | | | | |
| centipoise | | | | |
| Uncooked acid- | 0 | 0.00 | 120 | 9.0 |
| modified corn starch | | | | |
| having a hot water | | | | |
| viscosity of 180 BU | | | | |
| Sodium | 2 | 0.20 | 2.4 | 0.2 |
| Trimetaphosphate | | | | |
| Dispersant | 5 | 0.49 | 5 | 0.4 |
| Retarder | 0.2 | 0.020 | 0.1 | 0.01 |
| Paper Fiber | 0 | 0.000 | 12 | 0.90 |
| PVA | 0 | 0.000 | 12.9 | 0.96 |
| Total Water | 918 | 90 | 1001 | 75 |

As seen in Table 7, while the total water used by Board 4B is higher than that of the control, Board 4A, the amount of the total calcined gypsum is lower. This is significant because the calcination energy was reduced.

Table 8 depicts the stucco, water usage, and nail pull strength of Board 4B as compared with Board 4A, the control.

TABLE 8

| Ingredient | Board 4A (Control) | Board 4B |
|---|---|---|
| Board Weight (lbs/msf) | 1305 | 1646 |
| Nail Pull Strength (lbs) | 77.5 | 86.2 |

As seen in Table 8, Board 4B reduced stucco from 1020 lbs/msf to 536 lbs/msf. However, the total water usage was increased to 1001 lbs/msf because the board weight was increased to 1646 lbs/msf. Board 4B had a nail pull strength of 86.2 lbs, 9 lbs higher than the control Board 4A. This is significant because less stucco can be used to make a wallboard with similar strength.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. Stucco and water are fundamental ingredients in a slurry and are thus not considered additives. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. All amounts are by weight and not by volume, unless otherwise indicated. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A gypsum board comprising:
a set gypsum core disposed between two cover sheets, the core formed from a slurry comprising water, uncalcined gypsum, stucco, and starch binder;
the starch binder comprising (a) at least one uncooked non-substituted starch having a hot water viscosity of from about 20 Brabender Units to about 300 Brabender Units when the viscosity is measured by the HWVA method, (b) at least one pregelatinized starch, or (c) a combination of (a) and (b).

2. The gypsum board of claim 1, wherein the weight ratio of stucco to uncalcined gypsum is from 3:1 to 1:2.

3. The gypsum board of claim 1, wherein the slurry has a water/stucco ratio of less than 1.0.

4. The gypsum board of claim 1, wherein the uncooked non-substituted starch is tapioca starch, wheat starch, potato starch, and/or corn starch.

5. The gypsum board of claim 1, wherein the uncooked non-substituted starch has a hot water viscosity of from about 30 BU to about 300 BU.

6. The gypsum board of claim 1, wherein the uncooked non-substituted starch has a cold water viscosity of less than about 50 centipoise at 10% solids, as measured according to the BROOKFIELD® viscometer method.

7. The gypsum board of claim 1, wherein the pregelatinized starch is a pregelatinized partially hydrolyzed starch, wherein the hydrolysis at least partially depolymerizes the starch via acid and/or enzyme modification, wherein the pregelatinized partially hydrolyzed starch has a characteristic of a viscosity from about 35 centipoise to about 425 centipoise when the viscosity is measured while the pregelatinized partially hydrolyzed starch is subjected to conditions according to VMA method.

8. A method of making gypsum board, the method comprising:
mixing a slurry comprising water, uncalcined gypsum, a stucco, and a starch binder, the starch binder comprising (a) at least one uncooked non-substituted starch having a hot water viscosity of from about 20 Brabender Units to about 300 Brabender Units when the viscosity is measured by the HWVA method, (b) at least one pregelatinized starch, or (c) a combination of (a) and (b);
placing the slurry between two cover sheets to form a board precursor;
allowing the slurry in the precursor to set to form the board; and
cutting the board.

9. The method of claim 8, wherein the weight ratio of stucco to uncalcined gypsum is from 3:1 to 1:2.

10. The method of claim 8, wherein the slurry has a water/stucco ratio of less than 1.0.

11. The method of claim 8, wherein the uncooked non-substituted starch is tapioca starch, wheat starch, potato starch, and/or corn starch.

12. The method of claim 8, wherein the uncooked non-substituted starch has a hot water viscosity of from about 30 BU to about 200 BU according to the HWVA method.

13. The method of claim 8, wherein the uncooked non-substituted starch has a cold water viscosity of less than about 50 centipoise at 10% solids, as measured according to the BROOKFIELD® viscometer method.

14. The method of claim 8, wherein the pregelatinized starch is a pregelatinized partially hydrolyzed starch, wherein the hydrolysis at least partially depolymerizes the starch via acid and/or enzyme modification, wherein the pregelatinized partially hydrolyzed starch has a characteristic of a viscosity from about 35 centipoise to about 425 centipoise when the viscosity is measured while the pregelatinized partially hydrolyzed starch is subjected to conditions according to VMA method.

15. A slurry comprising:
water, uncalcined gypsum, stucco, and starch binder;
the starch binder comprising (a) at least one uncooked non-substituted starch having a hot water viscosity of from about 20 Brabender Units to about 300 Brabender Units when the viscosity is measured by the HWVA method, (b) at least one pregelatinized starch, or (c) a combination of (a) and (b);
wherein the uncalcined gypsum is provided in the slurry in an amount from 25% to 150% by weight of the stucco;
wherein the starch binder is provided in the slurry in an amount from 2% to 15% by weight of the stucco; and
wherein the slurry has a water/stucco ratio of less than 1.0.

16. The slurry of claim 15, wherein the weight ratio of stucco to uncalcined gypsum is from 3:1 to 1:2.

17. The slurry of claim 15, wherein the uncooked non-substituted starch is tapioca starch, wheat starch, potato starch, and/or corn starch.

18. The slurry of claim 15, wherein the uncooked non-substituted starch has a hot water viscosity of from about 30 BU to about 300 BU.

19. The slurry of claim 15, wherein the uncooked non-substituted starch has a cold water viscosity of less than about 50 centipoise at 10% solids, as measured according to the BROOKFIELD® viscometer method.

20. The slurry of claim 15, wherein the pregelatinized starch is a pregelatinized partially hydrolyzed starch, wherein the hydrolysis at least partially depolymerizes the starch via acid and/or enzyme modification, wherein the pregelatinized partially hydrolyzed starch has a characteristic of a viscosity from about 35 centipoise to about 425 centipoise when the viscosity is measured while the pregelatinized partially hydrolyzed starch is subjected to conditions according to VMA method.
